(19) United States
(12) Patent Application Publication
(10) Pub. No.: US 2024/0017200 A1
(43) Pub. Date: Jan. 18, 2024

(54) FILTER WITH FILTER MEDIA PACKS ARRANGED IN A V-SHAPE AND FLOW-OPTIMIZED SHAPING

(71) Applicant: Carl Freudenberg KG, Weinheim (DE)

(72) Inventors: Sascha SCHUMACHER, Wald-Michelbach (DE); Patrick WEBER, Weinheim (DE); Thomas SCHROTH, Bobenheim-Roxheim (DE); Renate TAPPER, Bensheim (DE)

(21) Appl. No.: 18/349,994

(22) Filed: Jul. 11, 2023

(30) Foreign Application Priority Data
Jul. 14, 2022 (DE) 10 2022 117 648.7

(51) Int. Cl. B01D 46/121; B01D 46/52; B01D 46/58

(52) U.S. Cl. CPC B01D 46/121; B01D 46/521; B01D 46/58; B01D 2265/06

(57) ABSTRACT

A cassette filter including a plurality of filter media packs and a frame for receiving the filter media packs. In each case, two filter media packs are arranged in a v-shaped manner. The frame possesses an inflow-side head plate, an outflow-side foot plate and two side plates. The head plate and/or the foot plate and/or the side plates have a flow-optimized shaping.

### CROSS REFERENCE TO RELATED APPLICATIONS

This application claims benefit to German Patent Application No. DE 10 2022 117 648.7, filed on Jul. 14, 2022, which is hereby incorporated by reference herein.

### FIELD

The invention relates to a cassette filter with a multiplicity of filter media packs.

### BACKGROUND

A wide range of filters are used in gas turbines, compressors, air-conditioning and ventilation systems in order to purify incoming air flows, e.g. cassette filters.

Such a cassette filter with a multiplicity of filter media packs is known from EP 3 831 461 A1, wherein in each case two filter media packs are arranged in a v-shape and a gas flows through the filter media packs in order to purify the gas from a raw gas side of the filter to a clean gas side of the filter. Such filters are also referred to as V-cell filters or in English as V-bank filters. The filter possesses a frame for receiving the filter media packs with protective grids for the filter medium.

US 2014 096493 A1 shows a filter with a similar structure.

Such filters can be pushed into a rectangular drawer of a filter receiver in a drawer-like manner. The filter then bears against the filter receiver with supporting surfaces of the head plate or the head frame and can be connected thereto, e.g. by screwing. It is commonplace that a filter receiver has a multiplicity of compartments in order to be able to receive a corresponding multiplicity of filters which are then arranged in a matrix-like manner and form a so-called filter wall. Forces acting on the components of the filter are diverted via the head plate or the head frame into the filter receiver with the drawers and a carrier construction.

The space which lies behind the carrier construction in the throughflow direction is shaded by the partially superficially closed side plates of the filters with their closed lateral surfaces. In US 2014 096493 A1, the lateral surfaces are, for example, closed over half the depth of the filter. There are cavities only in the rear half of the filter.

It is disadvantageous in the case of these known filters that this shading prevents the exploitation of the full clean gas-side cross-sectional potential, dead regions through which no flow takes place are thus generated and the flow substantially only exits from the filter element in the region of the foot plate. This restriction of the flow brings about an increased flow speed in regions of the filter which leads to greater air turbulence and thus increased flow resistance of the filter.

An uneven flow distribution within the filter media packs arranged in a v-shape can also arise if the frame of the filter has a geometry which is inexpedient in terms of flow both on the raw gas side and on the clean gas side. In particular the angular configurations known from the prior art of cross-members of the head plate and the foot plate are considered to be inexpedient in terms of flow.

As even distribution as possible of the throughflow speed at the filter medium is, however, advantageous for uniform loading of the filter medium with filtered-out particles, which enables a longer period of use of the filter before replacement becomes necessary.

### SUMMARY

In an embodiment, the present disclosure provides a cassette filter comprising a plurality of filter media packs and a frame for receiving the filter media packs. In each case, two filter media packs are arranged in a v-shaped manner. The frame possesses an inflow-side head plate, an outflow-side foot plate and two side plates. The head plate and/or the foot plate and/or the side plates have a flow-optimized shaping.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b illustrate a filter in two perspective views;

FIGS. 2a and 2b illustrate a perpendicular section through a filter and air flow along strut-shaped air guiding elements; and

FIGS. 3a and 3b illustrate a horizontal section through a filter and air flow along flanks of cross members.

### DETAILED DESCRIPTION

In an embodiment, the present invention provides a flow-optimized filter which has a low flow resistance and as uniform as possible a throughflow of the filter media packs and reduces the formation of air turbulence. In an embodiment, a flow-optimized filter is provided which can be effectively used in the filter wall.

### Technical Solution

According to an embodiment of the invention, it was recognized to be advantageous to provide the head plate and/or the side plates with a flow-optimized shaping.

An embodiment of the invention relates to a cassette filter with a multiplicity of filter media packs, wherein in each case two filter media packs are always arranged in a v-shaped manner in pairs, referred to as a so-called V-cell filter or in English as a V-bank filter. A gas flows through the filter media packs in order to purify the gas from a raw gas side of the filter to a clean gas side of the filter. The filter furthermore possesses a frame for receiving the filter media packs. The frame possesses an inflow-side head plate, an outflow-side foot plate and two side plates. According to an embodiment of the invention, the possibly segmented head plate and/or the possibly segmented foot plate and/or the possibly segmented side plates have a flow-optimized shaping to improve the flow of the gas to be purified through the filter. Possibly segmented means that the plates can be either in one piece or composed of several elements.

A low flow resistance of the filter is achieved thanks to the flow-optimized shaping of the head plate and/or the foot plate.

A clean gas-side reduction in turbulence and thus also a lower flow resistance of exiting gas are achieved thanks to the flow-optimized shaping of the side plates.

In one configuration of the cassette filter, the side plates are formed by trapezoidal lateral surfaces arranged in rows, wherein a trapezoidal lateral surface of a respective side plate, in particular an equal-sided-symmetrical trapezoidal lateral surface, is assigned to each v-shaped pair of filter media packs. According to an embodiment of the invention, there are thus v-shaped cavities, which are not closed and reach approximately to the head plate, between limbs of adjoining trapezoidal lateral surfaces. In other words: the cavities have the form of an in particular isosceles triangle, the tip of which points towards the head plate. As a result of this, it is advantageously made possible that the purified gas can be effectively discharged perpendicular to the main throughflow direction. When using the filter in a filter wall, the dead regions between the respective filters can be reduced and the clean gas-side cross-sectional potential is more effectively exploited.

According to an embodiment of the invention, strut-shaped air guiding elements are arranged in at least one of the cavities between limbs of trapezoidal lateral surfaces which adjoin one another, which air guiding elements extend from the limb of a first trapezoidal lateral surface to the limb of the next trapezoidal lateral surface and thus connect the trapezoidal lateral surfaces to one another. The term limbs refers in this case to the limbs of the trapezoidal shape. The strut-shaped air guiding elements serve to divert the flow, namely the purified gas perpendicular to the main throughflow direction. As a result of this, undesirable turbulence of the gas on the clean gas side of the filter can be advantageously reduced. The side plates are thus provided with a flow-optimized shaping.

In a further embodiment of the filter, the air guiding elements are arranged in at least one plane parallel to the head plate and foot plate and thus also parallel to the base sides of the trapezoidal lateral surfaces. They can also lie in the plane of the respective side plate. In particular, the air guiding elements are arranged in at least two parallel planes, hence there are at least two struts in each case in one cavity, which struts are spaced apart from one another.

In an embodiment, the air guiding elements can project into the interior of the filter between the filter media packs. The air guiding elements can project to different extents and for this purpose have different depths. For example, the depth of the air guiding elements can thus increase from the side of the head plate towards the side of the foot plate. In the case of this configuration, the air flow through the filter and out of the filter can advantageously be influenced in a targeted manner.

In an embodiment, the air guiding elements can have guiding surfaces with a different inclination. The air guiding elements are inclined in particular relative to planes parallel to the head plate and foot plate, i.e. have an angle of inclination relative to the planes. For example, the inclination of the air guiding elements can thus increase from the side of the head plate towards the side of the foot plate.

In a preferred embodiment of the filter, the air guiding elements are formed as blades, namely with a cross-sectional profile in the form of an oval or a supporting surface.

In different embodiment variants, the air guiding element can be adjustable automatically, manually or by means of an actuator in terms of their orientation. As a result of this, an adjustment to the flow conditions which actually prevail can be performed and e.g. an adjustment of the filter to different applications can advantageously be performed.

It is also possible that the air guiding elements are created in each case from several components. An air guiding element which lies at the height of the foot plate could thus, for example, be composed of a half-shell of the side plate and a half-shell of the foot plate.

In a refined embodiment, the air guiding elements can be embodied as additional components which are as necessary subsequently clipped into the fully mounted filter or fastened thereon in another manner.

Embodiments of the invention also relate to a cassette filter, in the case of which the head plate and the foot plate have in each case plate-shaped cross members assigned to the filter media packs, which cross members extend from one side plate to the other side plate. According to an embodiment of the invention, flanks of the cross members, which likewise extend from one side plate to the other, of head plate and/or foot plate, i.e. partial surfaces of the cross members located in the flow, are embodied in a bulbous manner. Embodied in a bulbous manner means in this case that the partial surfaces have a convex bulge. Here, either all of the flanks or only some flanks, e.g. only the flanks of the cross members of the head plate or only the flanks of the cross members of the foot plate, can be embodied in a bulbous manner. The bulbous embodiment differs from the square-edged embodiment in the prior art. The head plate and/or the foot plate are therefore provided with a flow-optimized shaping. A low flow resistance of the filter is advantageously achieved as a result of the bulbous embodiment according to the invention.

It was discovered in experiments that the throughflow can be further optimized if in each case two flanks oriented towards one another of adjacent cross members form a Venturi nozzle, wherein the narrow point of a respective Venturi nozzle is realized by the bulbous flanks.

An embodiment of the invention also relates to a filter wall with a multiplicity of filters received in a matrix-like manner in a filter receiver, which filters are embodied as described above.

The described embodiments of the invention and the described advantageous further developments of the invention also represent advantageous further developments of the invention also in combination with one another, insofar as this is technically expedient.

In terms of further advantages and configurations of embodiments of the invention which are advantageous from a constructive and functional perspective, reference is made to the description of exemplary embodiments with reference to the enclosed figures.

Embodiments of the invention should be explained in even greater detail on the basis of enclosed exemplary figures. Elements and components which correspond to one another are provided with identical reference numbers in the figures. A true-to-scale representation was dispensed with for the purpose of improved clarity of the figures.

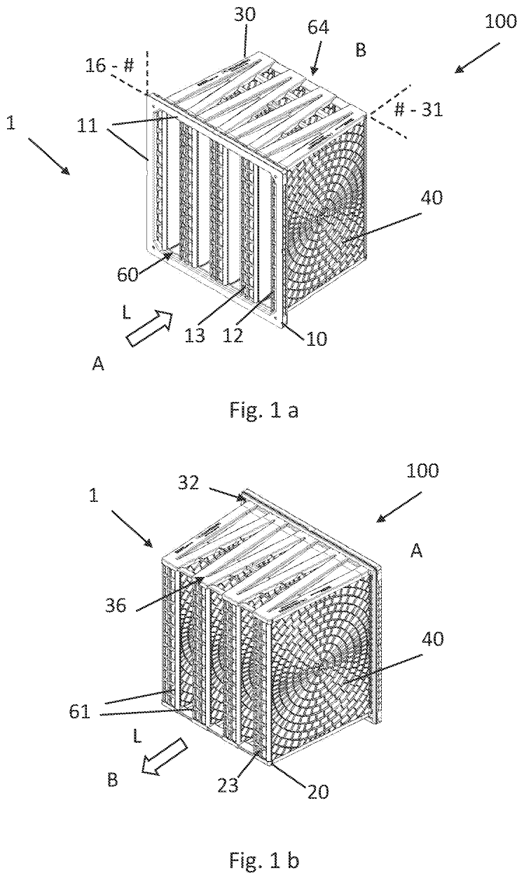

FIGS. 1a and 1b show a cassette filter 100 according to an embodiment of the invention in two perspective views.

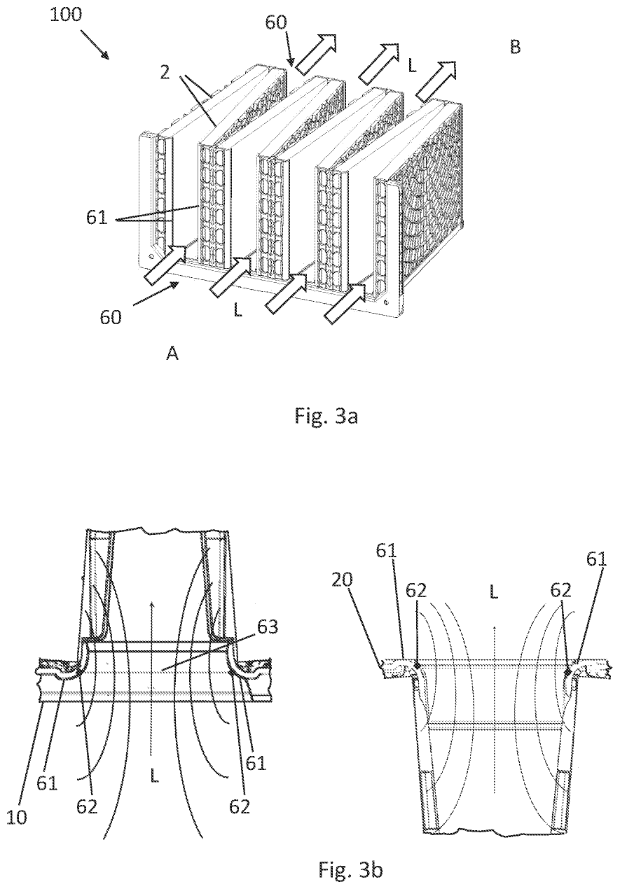

The cassette filter 100 possesses eight filter media packs 2 (cf. FIG. 3a) which can be formed from pleated filter medium. In each case two filter media packs 2 are always arranged in a v-shape in pairs. A gas flows through the filter media packs 2 for cleaning of the gas from a raw gas side A of the filter 100 to a clean gas side B of the filter 100 in throughflow direction L.

A frame 1 is provided to receive the filter media packs 2. The frame 1 is constructed from a head plate 10, a foot plate 20 and two side plates 30. The head plate 10 and the foot plate 20 and the side plates 30 have a flow-optimized shaping 60, 64 which is explained in greater detail on the basis of the further figures.

FIG. 1a shows the filter 100 from the raw gas side A and FIG. 1b from the clean gas side B.

FIG. 1a indicates the plane 16 in which the head frame 11 of the head plate 10 is located and the plane 31 in which the side plate (30) (at the top in the image) is located. It is apparent from FIG. 1b that the side plates 30 have a shoulder 32 in the region in which they are connected to the head plate 10, which shoulder 32 can also serve the purpose of easier receiving in a filter wall.

In each case one protective grid 40 is arranged on the clean gas side (A) on a respective filter media pack 2. The filter medium of the filter media packs 2 is held in its position by the protective grid 40, protected from damage and protects downstream systems from damage. In the represented embodiment, a respective protective grid 40 is formed in one piece as an injection moulded part and is connected, e.g. cast, in a cohesively bonded manner to the frame 1 at its circumferential edge in the region of an edge strut.

The head plate 10 possesses two single cross members 12 which are assigned to a filter media pack 2 and three double cross members 13 which are assigned to two filter media packs 2 arranged next to one another. The foot plate 20 possesses four double cross members 23 which are assigned in each case to a pair of filter media packs 2.

The side plates 30 are formed by trapezoidal lateral surfaces 36 arranged in rows, wherein a respective trapezoidal lateral surface 36 is assigned in each case to a pair of filter media packs 2 arranged in a v-shaped manner.

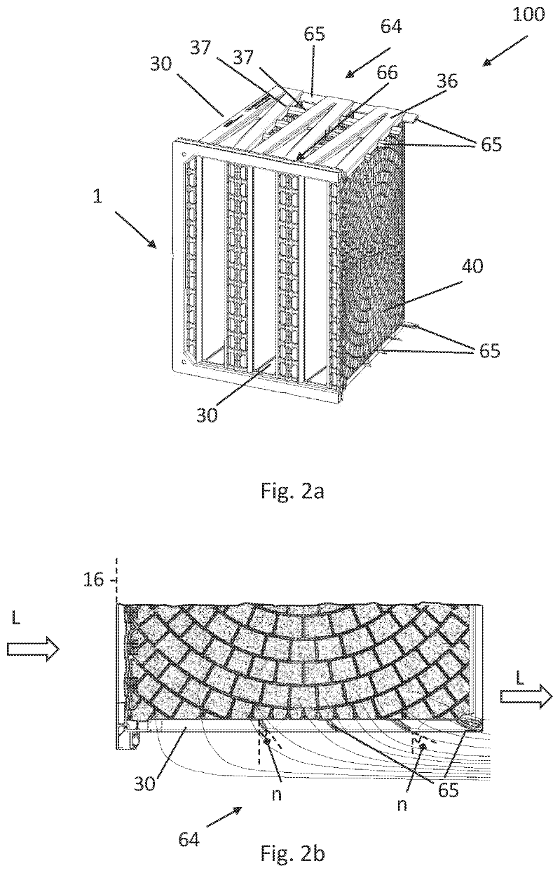

The flow-optimized shaping 64 of the side plates 30 is explained in greater detail on the basis of FIGS. 2a and 2b.

The flow-optimized shaping 60 of the head plate 10 or the foot plate 20 is explained in greater detail on the basis of FIGS. 3a and 3b.

FIG. 2a shows a perpendicular section through a filter 100 and FIG. 2b shows the air flow L along the strut-shaped air guiding elements 65.

The side plates 30 are formed by trapezoidal lateral surfaces 36 arranged in rows, wherein three are still apparent in FIG. 2a.

There are thus v-shaped cavities 66, which are not closed and reach to the head plate 10 and have the form of an acute, isosceles triangle, the tip of which lies at the level of the head plate 10, between limbs 37 of adjoining trapezoidal lateral surfaces. For the purpose of clarity, the arrow tip of the line of the reference number 66 is directed at the position of the tip of the triangle.

Strut-shaped air guiding elements 65 are arranged in the cavities between limbs 37 of adjoining trapezoidal lateral surfaces 36, namely in the plane of the side plate 31 and in several planes parallel to the plane of the head plate 16 (and thus also to the foot plate 20).

The air guiding elements 65 are configured in blade form and possess guiding surfaces with a different angle of inclination n, wherein the angles of inclination n are indicated in FIG. 2b relative to a respective plane parallel to the plane 16 of the head frame.

The air guiding elements 65 can also be adjustable in terms of their orientation.

FIG. 3a shows a horizontal section through a filter 100.

FIG. 3b shows the air flow L along the flanks 61 of cross-members 13, 23 with the aid of flow lines.

The flanks 61 of the cross members 12, 13, 23 of head plate 10 (left) and foot plate 20 (right) are embodied to be bulbous and possess a convex bulge 62 which reduces the air resistance and optimizes the throughflow.

In each case two flanks 61 form a Venturi nozzle, wherein the narrow point of the Venturi nozzle lies between the bulges 62.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A cassette filter comprising:
a plurality of filter media packs; and
a frame for receiving the filter media packs,
wherein in each case two filter media packs are arranged in a v-shaped manner,
wherein the frame possesses an inflow-side head plate, an outflow-side foot plate and two side plates, and
wherein the head plate and/or the foot plate and/or the side plates have a flow-optimized shaping.

2. The cassette filter according to claim 1, wherein the side plates are formed by trapezoidal lateral surfaces arranged in rows, and strut-shaped air guiding elements are arranged in at least one of cavity between limbs of trapezoidal lateral surfaces which adjoin one another.

3. The cassette filter according to claim 2, wherein the air guiding elements are arranged in at least one plane parallel to the head plate and foot plate.

4. The cassette filter according to claim 3, wherein the air guiding elements have guiding surfaces with different inclinations.

5. The cassette filter according to claim 1, wherein the air guiding elements are formed as blades.

6. The cassette filter according to claim 1, wherein the air guiding elements are adjustable in their orientation.

7. The cassette filter according to claim 1, wherein the head plate and the foot plate have in each case plate-shaped cross members assigned to the filter media packs, and
wherein flanks of the cross members of the head plate and/or the foot plate are embodied in a bulbous manner.

8. A filter wall with a plurality of the cassette filters according to claim 1, wherein the cassette filters are received in a matrix-like manner in a filter receiver.

9. The cassette filter according to claim 3, wherein the air guiding elements are arranged in at least two parallel planes.
